(19) United States
(12) Patent Application Publication
(10) Pub. No.: US 2011/0238591 A1
(43) Pub. Date: Sep. 29, 2011

(54) AUTOMATED PROFILE STANDARDIZATION AND COMPETENCY PROFILE GENERATION

(75) Inventors: Jason David Kerr, Auckland (NZ); Stephen Anthony Moir, Auckland (NZ); Paul Anthony O'Donnell, Christchurch (NZ); Curt J. Witte, Chicago, IL (US); Geoffrey Byron Weathersby, Solana Beach, CA (US)

(73) Assignee: FINDLY, INC., Palo Alto, CA (US)

(21) Appl. No.: 13/071,035

(22) Filed: Mar. 24, 2011

Related U.S. Application Data
(60) Provisional application No. 61/316,838, filed on Mar. 24, 2010.

(51) Int. Cl. G06Q 10/00

(52) U.S. Cl. 705/321

(57) ABSTRACT

A system and method are described for standardizing disparate personal profile information from different sources into a standardized competency based profile. The standardized competency profile enables equalized and fast candidate evaluation and selection across multiple sources for recruiting, education, training and career management purposes.

### CROSS REFERENCE TO RELATED APPLICATIONS

This application claims the benefit of U.S. Provisional Application No. 61/316,838 filed on Mar. 24, 2010, which is hereby incorporated by reference herein.

### BACKGROUND

1. Field of Art

The embodiments disclosed herein generally relate to talent identification, and more particularly, standardizing disparate personal profile information from different sources into a standardized competency based profile.

2. Description of the Related Art

Employers spend roughly $58 billion each year searching for potential job candidates (i.e., talent). Typically, employers search for talent by posting available positions on conventional career websites and/or conventional corporate websites. Job seekers may create personal profiles and/or resumes which are posted on these sites in order to apply for the available positions. Each site typically collects and stores information according to their own system thereby resulting in variations in data formats and type of information recorded in the personal profiles.

To locate the potential candidates, employers must search these conventional websites for the candidates. However, not only is the time spent searching these websites extremely time consuming for employers, the results of searching these websites is inconsistent because of the variation in data format, the type of information included in the personal profiles from the disparate websites, and the varying search algorithms used by each site thereby resulting in different results to a common search query. Additionally, because most job seekers fail to actively update their profiles/resumes with current information, the information available to employers on conventional talent seeking websites is often out of date. Thus, the return-on-investment for employers is negligible since conventional sources for job candidates yield unsatisfactory results. Moreover, employers are unable to engage with candidates on a periodic basis through the conventional websites. Thus, employers must continue spending money in a cyclic fashion in order to continually meet new candidates.

### BRIEF DESCRIPTION OF THE DRAWINGS

FIG. 1 illustrates a computing environment of a profile optimization server according to one embodiment.

FIG. 2 illustrates a personal website containing profile information according to one embodiment.

FIGS. 3A through 3G illustrate methods for identifying location information from a raw profile according to one embodiment.

FIG. 4 illustrates an example of a geocoded profile in a search scenario according to one embodiment.

FIGS. 5A and 5B illustrate methods for standardizing education information according to one embodiment.

FIG. 6 illustrates a method for standardizing disparate job titles into standardized occupational codes according to one embodiment.

FIG. 7 illustrates a method for identifying job candidates according to one embodiment.

The figures depict embodiments for purposes of illustration only. One skilled in the art will readily recognize from the following description that alternative embodiments of the structures and methods illustrated herein may be employed without departing from the principles described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

A system (and method and computer readable storage medium) include automated standardization of profile information retrieved (through either a push or pull of the data) from disparate sources to generate an optimized “living” resume regardless of the format of the retrieved information. The living resume is optimized in order to improve the identification of the resume during search. By way of example, profile information from disparate sources is collected that represents a raw profile (e.g., data retrieved “as is”). From the raw profile, education information and work experience of the person associated with the raw profile is standardized according to a predetermined taxonomy, social behavior, and interests of the person associated with the raw profile are derived according to the predetermined taxonomy thereby creating an optimized living resume. The predetermined taxonomy may be fixed and could be structured to evolve, e.g., by “learning” of what is received and suggesting newer or updated taxonomies.

The optimized living resume describes the education, work experience information, predicative skills, competency capability, and various derived social indicators (behaviors) of the individual associated with the resume according to the taxonomy. The individual associated with the living resume need not actively maintain it. Modification of the profile information on the disparate sources is managed by the system, which in turn updates the living resume.

The system also allows employers to actively engage with potential employees of the company. Mechanisms such as user interface (UI) elements may be placed on the employer's website or on sources of profile information such as social networking sites or job postings. People who are interested in the company may select the user interface element thereby indicating interest in the company. Selection of the UI element by a person grants permission to the system to connect with the person similar to how connections are created in social networking systems. Over time as more individuals indicate interest in the employer, the employer's own talent community begins to develop. The talent community includes those individuals that have indicated interest in the employer. The system also allows for the mechanisms (e.g., the UI elements) to indicate a person's interest in general genres rather than an interest in a specific employer. In one embodiment, these genres may describe a work industry of interest (e.g., engineering, human resources, legal industry, biotechnology, etc), development phase of companies of interest (e.g., startup or mature), jobs catered towards a community of people (e.g., students looking for jobs), or a general interest in jobs.

The system may search the employer's talent community for potential job candidates thereby localizing the search for job candidates to individuals that are interested in the employer. The system accesses the living resumes of the job candidates in the talent community and scores the resumes according to search criteria provided by the employer as well as factors including the length of time in which the person performed the job and the length of time since the person last performed the job.

The criteria provided by the employer may simply be a job title. However, to provide more meaningful results, the employer may provide instead of or in addition to the job title skills and/or education required by the position. This allows the system to locate individuals that may have not formally held the job title during their work history, but who may nonetheless possess the skills and/or education to perform the job. Additionally, the criteria provided by the employer may be profile information of a current employee of the company which indicates to the system to locate individuals from the talent community that possess similar attributes as the person currently working for the employer. Note that the system may also perform a more general search for potential job candidates for those individuals that expressed an interest in a general genre rather than a company as will be described in further detail below. Thus, the system described herein provides an improved method for identifying talent for employers.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### Computing Environment

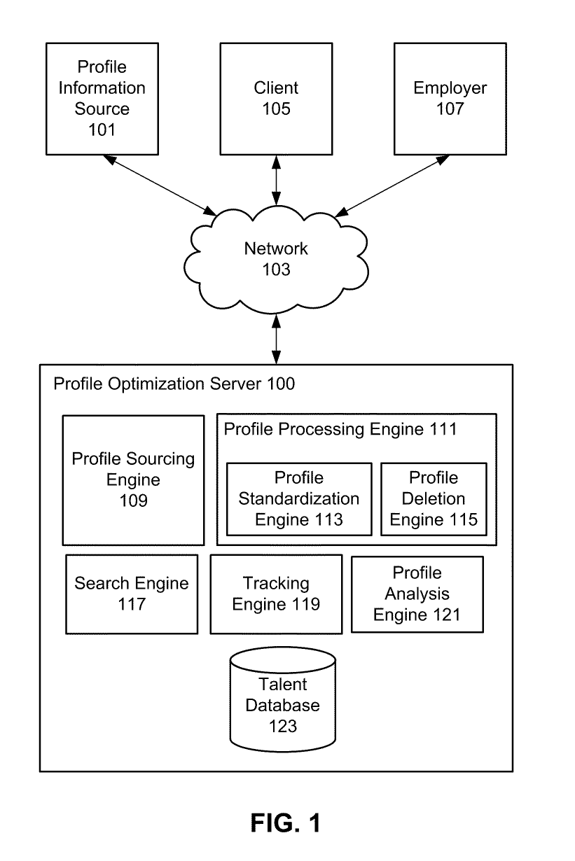

Referring now to FIG. 1, illustrated is a high-level block diagram illustrating one example of a computing environment for use with the configuration described herein. The computing environment includes a profile optimization server computing system 100, a profile information source computing system 101, one or more client computing systems 105, one or more employer computing systems 107 and a network. The profile optimization server 100, the profile information source 101, the client 105, and the employer 107 are communicatively coupled through the network 103.

The profile optimization server 100 is configured to standardize profile information from disparate sources into a standardized competency profile or optimized “living resume” (hereafter “living resume”). In one embodiment, a living resume is a data representation of a person that is associated with the resume. The living resume is optimized in a manner that is beneficial for recruiting purposes compared to the raw profile from the disparate sources. The optimized living resume includes factual information acquired from the corresponding raw profile as well as information that has been predicted and derived from the raw profile itself as will be further described below. The information is formatted according a taxonomy which allows the person associated with the living resume to be more locatable for recruitment purposes. As the person updates his or her profile information stored on the disparate sources, the profile optimization server 100 accordingly updates the corresponding living resume. Thus, living resumes are always up to date with current information for the person associated with the resume. These living resumes allow employers 107 or other third-parties to identify potential job candidates (i.e., talent) for available positions at the employers. Because living resumes are standardized according to the discussion herein, employers 107 are provided consistent results of job candidates who fulfill the requirements for available positions as will be later described.

Additionally, the profile optimization server 100 is configured to allow employers and job seekers to stay connected with one another through the profile optimization server 100. A job seeker that has interest in working for a particular company may provide explicit interest in the company even though positions of interest are currently unavailable. The indication allows the company to keep track of the development of the job seeker over time. When future positions become available that fit the attributes of the job seeker, the job seeker may be contacted about the position. Thus, as connections between the company and job seekers are being made, the need for conventional career posting websites is no longer needed as the company's own community of talent is constantly expanding.

The profile optimization server 100 is in communication with a profile information source 101 via the network 103. The network 103 may be an Internet or any combination of a LAN, a MAN, a WAN, a mobile, wired or wireless network, a private network, or a virtual private network. In one embodiment, a profile information source 101 is a source of profile information for people from which living resumes are created. People who have accounts with these profile information sources 101 typically provide profile information to these sources 100 which are associated with the accounts. The profile information may comprise a name, date of birth, institutions attended (e.g., universities), employer information, work experience, and/or skills. Examples of profile information sources 101 are social networking sites such as FACEBOOK, LINKEDIN, TWITTER, and MYSPACE or any other source of profile information such as web blogs. While only a single profile information source 101 is shown in FIG. 1, in general any number of profile information sources 101 is supported and can be in communication with the profile optimization server 100 at any time.

The profile optimization server 100 is also in communication with the employer 107 via the network 103. The employer 107 is representative of a company that utilizes the profile optimization server 100 for talent identification purposes. The employer 107 may search the profile optimization server 100 for potential job candidates to fulfill available positions at the company. In one embodiment, the employer 107 may also be in communication with a job seeker represented by client 105. In one embodiment, the client 105 may view job postings describing available positions at the employer 107 at the employer's website. While only a single client 105 is shown in FIG. 1, in general very large numbers (e.g., millions) of clients are supported and can be in communication with the employer 107, profile information source 101, and/or the profile optimization server 100 at any time. The client 105 can be implemented using any of a variety of different computing devices, some examples of which are personal computers, digital assistants, personal digital assistants, cellular phones, mobile phones, smart phones and laptop computers.

### Profile Optimization Server

Continuing with FIG. 1, the profile optimization server 100 comprises of a series of engines that are further described herein. In one embodiment, the profile optimization server 100 utilizes Platform as a Service (PaaS) hardware. PaaS is a platform layer of cloud computing, offering hardware architecture services over the World Wide Web. The server 100 utilizing PaaS speeds up deployment by allowing hardware to be functional online quickly and economically. In one embodiment, the profile optimization server 100 comprises a profile sourcing engine 109, a profile processing engine 111, a search engine 117, a tracking engine 119, a profile analysis engine 121, and a talent database 123. Note that in other embodiments, the profile optimization server 100 may comprise other engines than those illustrated in FIG. 1.

The profile sourcing engine 109 collects profile information from profile information sources 101 regardless of the information's original format from the sources 101. In one embodiment, the profile information comprises resume information such as education information, work experience, skills, and/or location information. Note that in other embodiments, other information may be included in the profile information. In one embodiment, the profile sourcing engine 109 collects the profile information using publically available permissive application programming interfaces (APIs). For external scraping of profile information sources 101 that do not provide API or other such permissive access, a role is placed on Azure (the Window Azure Queue delivers the messages for the application), which requests files from a service for web crawling and processing web content (e.g., 80 Legs). The files are read one profile at a time and processed by the profile sourcing engine 109.

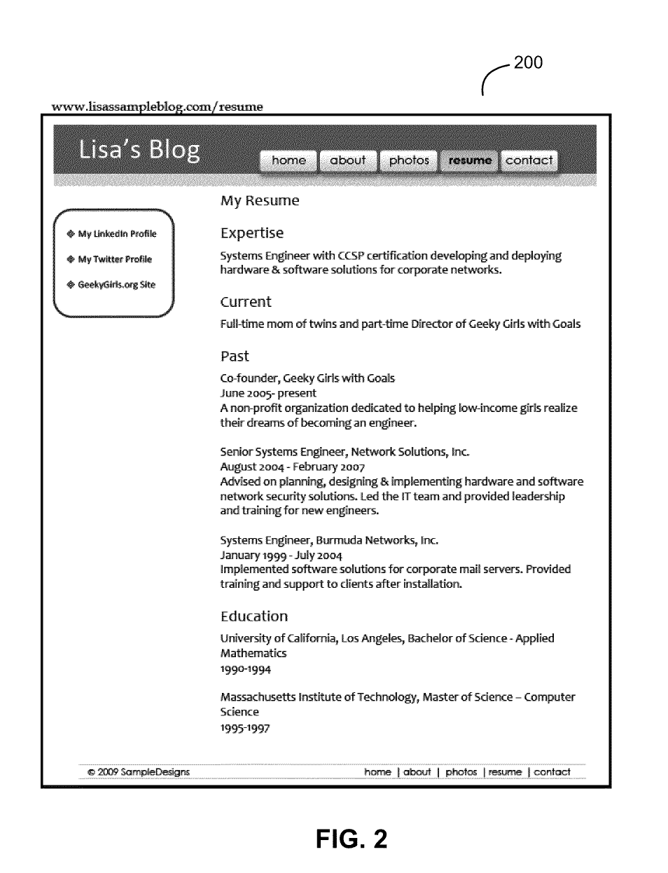

Referring to FIG. 2, a personal profile 200 from a profile information source 101 is shown. In this example, the personal profile 200 comprises a person's resume posted on the person's web blog. The profile sourcing engine 109 parses the profile information identified from a profile information source 101 and converts the information into a data format such as the HR-XML format. HR-XML is standardized Extensible Markup Language (XML) vocabularies for human resources (HR) data. In one embodiment, profile information converted into the HR-XML format is a raw profile which is a data representation of the person associated with the profile.

Note that the profile information collected from the profile information sources 101 may be new profile information for a new profile in the profile optimization server 100 or may be updated profile information to update an existing profile in the server 100. The profile processing engine 109 may collect or be provided profile information from the profile information sources 101 at predefined periods of time such as an hourly, daily, weekly, or monthly basis in order to ensure that the profile information is current.

Generally, the profile processing engine 111 processes raw profiles received from the profile sourcing engine 109. As shown in FIG. 1, the profile processing engine 111 comprises a profile standardization engine 113 and a profile deletion engine 115 which will be described in further detail below. The profile processing engine 111 verifies if a raw profile comprises sufficient data to be searchable. In one embodiment, a raw profile must comprise location information to be considered searchable. If the profile does not contain sufficient data to be searchable, profile deletion engine 115 discards the profile.

The profile processing engine 111 also determines if a profile exists in the database. If the profile exists, the profile deletion engine 115 of the profile processing engine 11 deletes the profile. If the profile does not exist, the profile processing engine 111 creates a profile identification (ID) for the profile which identifies the profile. The profile processing engine also saves display data of the profile. The display data describes how to display the profile information of a profile so that during a request for the profile the amount of information needed for retrieval is minimized.

In one embodiment, the profile processing engine 111 also stores in the talent database 123 various properties of the profile information as described in TABLE 1 below.

TABLE I

| Property | Details |
|---|---|
| SourceType | Details of the profile information source in which |
| | the profile information was obtained from. E.g., |
| | Quiet Agent, LinkedIn, AllianceQ, WMW. |
| SourceID | A unique identifier for a specific profile |
| | information source 101: e.g., a URL. |
| ProfileID | An integer. |
| ClaimID | This ID is only set if the Profile has been claimed. |
| SponsorType | An enumeration type that determines if the profile |
| | appears in the sponsored listing. |
| Token | Access authentication token for the profile |
| | information source. |
| Created | When the profile was created. |
| Modified | When the profile was last modified. |

In one embodiment, the properties of a profile include the SourceType. The SourceType (or source type) describes the profile information source 101 of the profile information such as FACEBOOK or LINKEDIN. The SourceID (or source identification (ID)) describes a unique identifier for the profile information source 101 such as the uniform resource locator (URL) associated with the profile information source 101 or a unique intenger. The profileID (or profile identifier (or ID)) is an identifier for the profile such as a distinct integer assigned to the profile. The ClaimID (or claim identifier (or ID)) indicates that a profile been claimed by a person as their own profile; after the person is identified and verified. The SponserType (or sponsor type) indicates that the person associated with the profile has paid the entity associated with the profile optimization server 100 to display the profile more prominently in relevant search results or other locations. The Token (or authentication token) is provided by a public API corresponding to a profile information source 101 from which the raw profile is obtained. In one embodiment, the Token grants the profile optimization server 100 access to the person's profile on the profile information source 101. For example, a social networking site such as LINKEDIN may provide the profile optimization server 100 a token that allows the server 100 to access a raw profile within LINKEDIN. The Created property (or created property) and Modified property (or modified property) respectively indicate when the profile was created and last modified (updated).

Note that in one embodiment the profile information itself is not stored. The profile information itself continues to reside on the profile information source 101 from which the information was collected and is not copied or otherwise transferred over. Rather, the profile optimization server 100 stores the properties of the profile described above rather than the profile information itself. Thus, to access the profile information, the profile optimization server 100 identifies the properties of the profile which point back to (identify) profile information source 101. In this embodiment the configuration reduces the need for storage space of the profile. Moreover, because the information continues to reside at the original source, the information has a greater probability of being most up to date and accurate from the perspective of the owner of the profile.

In one embodiment, the profile processing engine 111 also comprises a profile standardization engine 113. The profile standardization engine 113 standardizes the information in a raw profile to create an optimized living resume as will be further described in more detailed below.

Continuing with FIG. 1, the search engine 117 processes search queries for job candidates from employers 107 and provides search results to fulfill the search queries. Receipt of a query causes the search engine 117 to search for profile IDs that are relevant to the search query. In one embodiment, the search query may include search criteria associated with an available position at an employer 107. For example, the search criteria may include a job title of the available position at the employer 107. Alternatively, the search criteria may include the skills required for an open position at the employer 107 which causes the search engine 117 to search for living resumes that indicate the required skills. In another embodiment, the search criteria may indicate profile information of an employee currently working for an employer 107. This indicates to the search engine 117 to identify another individual with similar features (e.g., skills, education, and/or location) as the individual.

The tracking engine 119 periodically analyzes profiles of people who have indicated interest in an employer 107. A person may view a website of the employer 107 (through client 105) and indicate an interest in the employer 107. In one embodiment, the interest may be a general interest in the employer or an interest to work for the employer 107 at this time or in the future.

To provide the indication, the person may select a user interface (UI) element such as a “like” or “follow” button on the employer's website. The selection of the UI element grants permission to the profile optimization server 100 to track the person's living resume over time. The tracking engine 119 thereby maintains a connection with the person and periodically analyzes the person's living resume to identify whether the person may be qualified for an open position at the employer 107. Thus, the profile optimization server 100 may still engage with these individuals who do not want to apply for a position at this time. This inherently results in more interest in the employer 107 since individuals are not required to spend the time applying for a position at that moment. Note that the user interface element indicating an interest in an employer 107 may be placed on websites other than the employer's website such as on websites associated with profile information sources 101 (e.g., social networking websites).

For those individuals who indicated interest in an employer 107, the tracking engine 119 creates an identifier for each individual and associates the user identifier with an identifier for the employer 107. These identifiers are stored in the talent database 123. The talent database 123 represents a community of talent from which the employer 107 may search from to locate potential job candidates. Thus, as more individuals indicate interest in the employer 107, the employer's talent community further increases. This allows the employer 107 to search for talent from among individuals who have genuine interest in the employer 107.

Rather than indicating an interest in a specific employer 107, a person may instead select a user interface (UI) element such as a “like” or “follow” button that indicates a general genre of interest. In one embodiment, the genre describes more generic categories of interest for the person such as a work industry of interest (e.g., engineering, human resources, legal industry, biotechnology, etc), development phase of companies of interest (e.g., startup or mature), jobs catered towards a community of people (e.g., students looking for jobs), or just a general interest in jobs itself. More general communities of talent are formed based on the indicated interest as described previously above for the company specific communities.

In one embodiment, an auto-population function is provided for those individuals with a living resume. The profile optimization server 100 may receive an indication that a person has selected a UI mechanism such as a “quick apply” UI element which is provided on a job posting of a website. The quick apply mechanism allows an individual viewing a job application associated with the posting to complete the application using information from the person's living resume. The profile optimization server 100 receives the indication of the selection of the quick apply mechanism and accesses the person's living resume. Based on the form fields of the application, the profile optimization server 100 selects the appropriate information from the living resume to complete the application. For example, the profile optimization server 100 may auto complete the “Work History” or “Education” form fields of the application using information from the living resume.

The profile analysis engine 121 analyzes profiles of those individuals in the talent database 123 to identify demographics of the people who are interested in the company 107. In short, the profile analysis engine 121 identifies the type of people that the employer 107 attracts. For example, the profile analysis engine 121 may identify the gender, age, nationality, and or location of the people who have indicated interest in the employer 107. This demographic information allows the employer 107 to better target its job positions to people who fit the demographics of the individuals indicated in the talent database 123.

The profile analysis engine 121 also can be configured to analyze optimized living resumes as well as the profile information source 101 to derive social behaviors of the people associated with the resumes. The profile analysis engine 121 can be configured to predict based on the derived behaviors when a person may switch jobs and/or where the person would more likely be willing to relocate for a job.

For example, the profile analysis engine 121 may identify from a person's optimized living resume that the person switches jobs or industries every 4 years and will be searching for a new job in the next month. Accordingly, the profile analysis engine 121 may communicate with the search engine 117 to identify available positions that match the attributes of the individual and provide those positions to the person. Additionally, the profile analysis engine 121 may identify from the profile information source 101 that the person has 300 friends in San Francisco, Calif., 100 friends in San Diego, Calif., and 75 friends in New York, N.Y. From the number of friends in each city, the profile analysis engine 121 may predict that the person would be more interested in a position in San Francisco rather than San Diego or New York. Alternatively, the profile analysis engine 121 may identify that all of the person's “best friends” and family members are located in New York thus providing an indication that the person may be more interested in a position in New York rather than San Diego or San Francisco.

In one embodiment, the profile analysis engine 121 identifies the demographics (e.g., age, gender, location, etc.) of the individuals in an employer's talent community. The profile analysis engine 121 analyzes the living resumes of these individuals to determine a generalization of the individuals that are typically interested in the employer 107. This allows the employer 107 to direct its resources in attracting further individuals that fit the identified demographics thereby increasing the return-on-investment spent on recruiting.

### Location Identification

In one embodiment, the profile standardization engine 113 converts a raw profile into an optimized living resume. Generally, the profile standardization engine 113 standardizes the location information, education information, and work experience information that is described in a raw profile. By standardizing the information, the information across different resumes is uniform thereby allowing easier evaluation of the resumes.

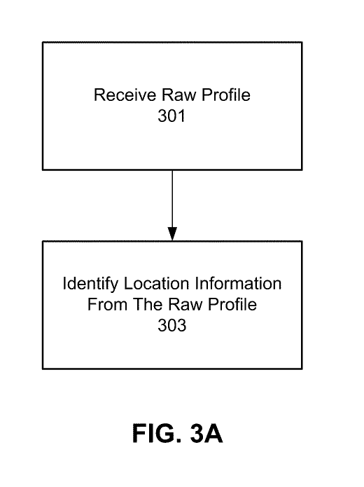

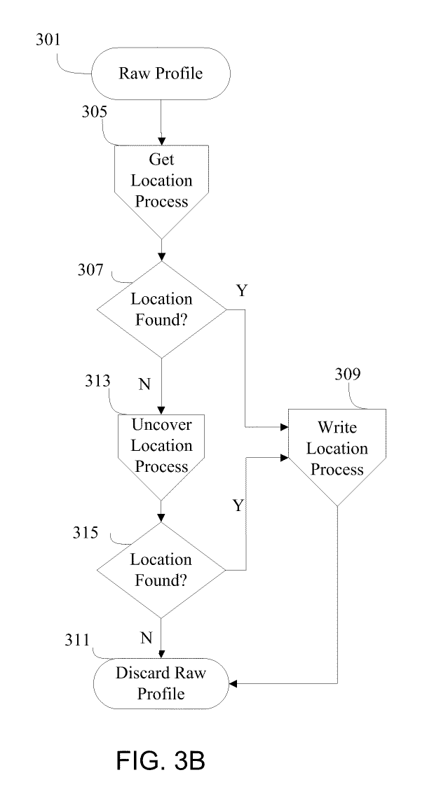

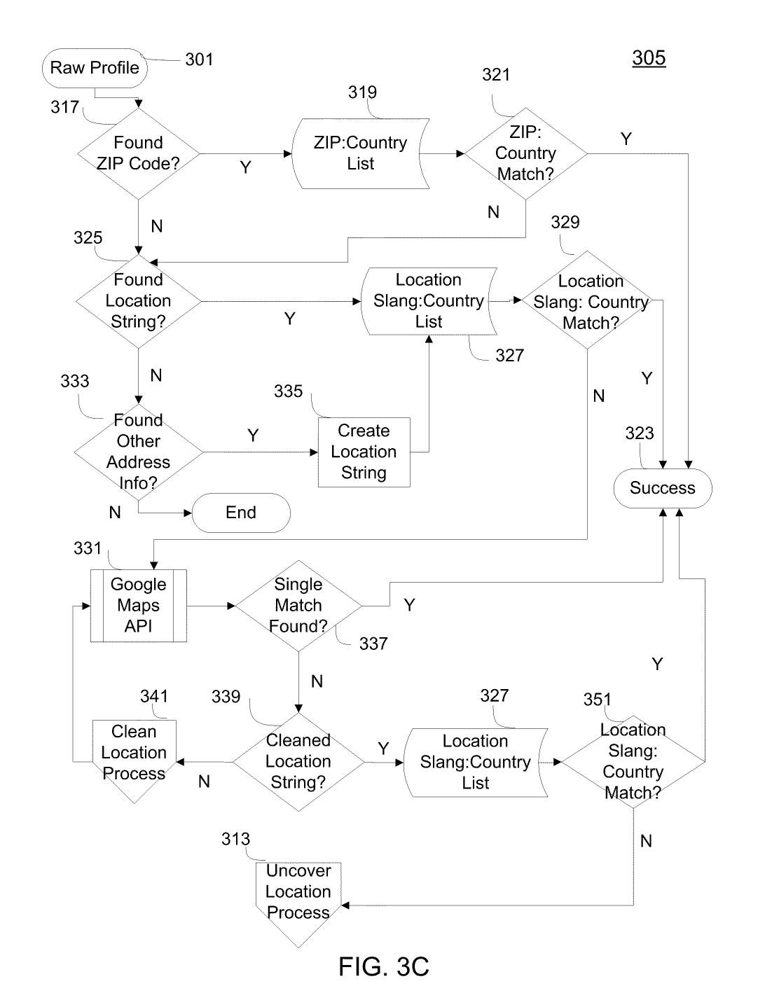

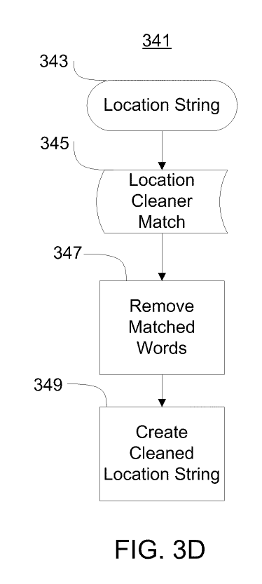

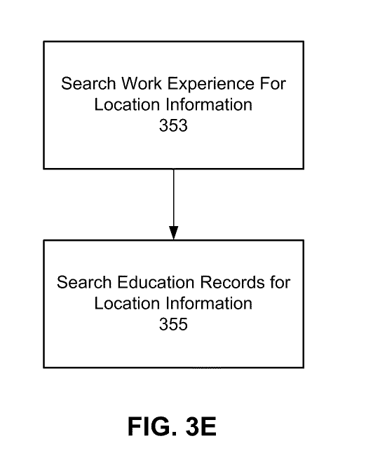

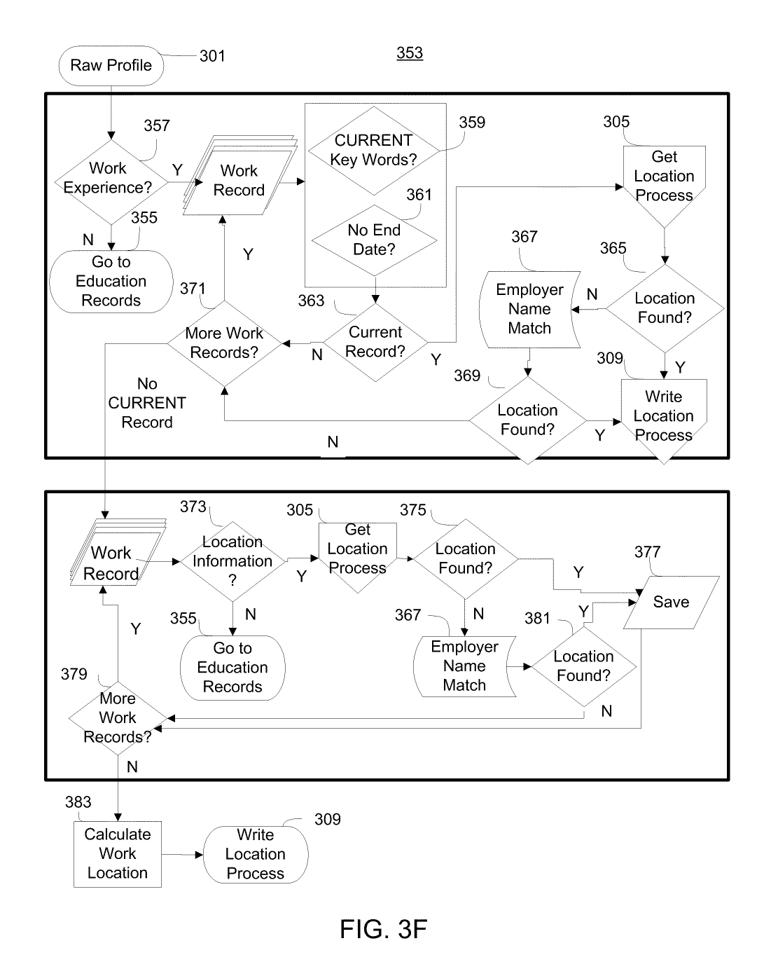

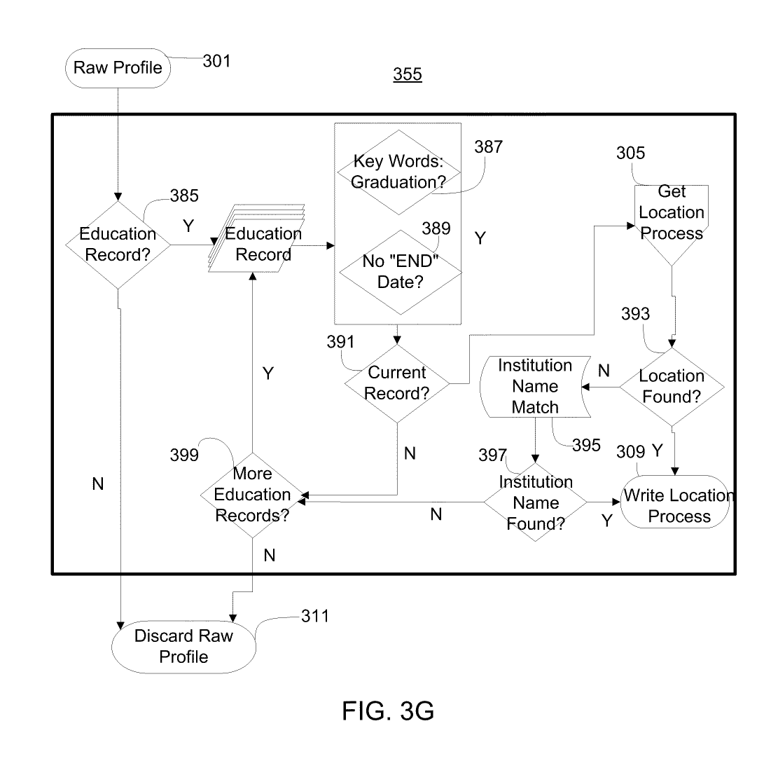

Referring now to FIG. 3A, one embodiment of an example process for identifying location information of a person associated with a raw profile is shown. The profile standardization engine 113 receives 301 the raw profile. As described previously, the raw profile comprises the HR-XML profile information collected from a profile information source 101. From the raw profile, the profile standardization engine 113 identifies 303 location information from within the raw profile. That is, the profile standardization engine 113 derives whatever location information is provided from the raw profile. Location information can be directly found in the raw profile data or may be formulated by any, or all, of the location discovery processes as will be further described below.

As previously mentioned, location information is directly identified from within a raw profile. In one embodiment, the types of location information may include a country name, a localized slang term for a region or area of a city, or a complete postal address set of city, state, country and a postal (or ZIP) code. Other types of location information also may be included in the raw profile in alternative embodiments, for example, employer or education location details.

Referring now to FIG. 3B, one embodiment of an example process for identifying location information from a raw profile is shown. The profile standardization engine 113 receives 301 the raw profile and performs a process 305 for getting (i.e., discovering) the location information from the raw profile. The get location process 305 will be described in further detail below with respect to FIG. 3C. The profile standardization engine 113 determines 307 whether location information is identified as a result of the get location process 305. If location information is identified as a result of the get location process 305, the location information is passed to the process 309 for writing the location.

In one embodiment, the write location process 309 is a geocoding process. The profile standardization engine 113 geocodes the location information (e.g., a postal code) identified from the raw profile to geographic coordinates that are associated with the raw profile. In one embodiment, the geographic coordinates are latitude and longitude coordinates that correspond to the identified location information and are representative of the residential location of the person that is associated with the raw profile. In one embodiment, a “Current Location” field of the raw profile is assigned a value that is equivalent to the geographic coordinates. After the identified location information has been geocoded, the raw profile is discarded 311 since the profile optimization server 100 does not store profiles locally.

In one embodiment, the profile standardization engine 113 further optimizes the raw profile for geo searching based on geocoded location information. The profile standardization engine 113 assigns a series of coordinate values defining the searchable areas that the person associated with the raw profile can be located. These coordinate values are pre-calculated and associated with the standardized living resume. The series of coordinate values is a set of pre-determined distances from the geo coordinates associated with the profile, such as 5, 10, 25, or 50 miles away from the geo coordinates that represent the person's location. The pre-calculated distances assigned to living resumes enable faster searching capability thereby eliminating the time and resource intensive processes of real-time calculations.

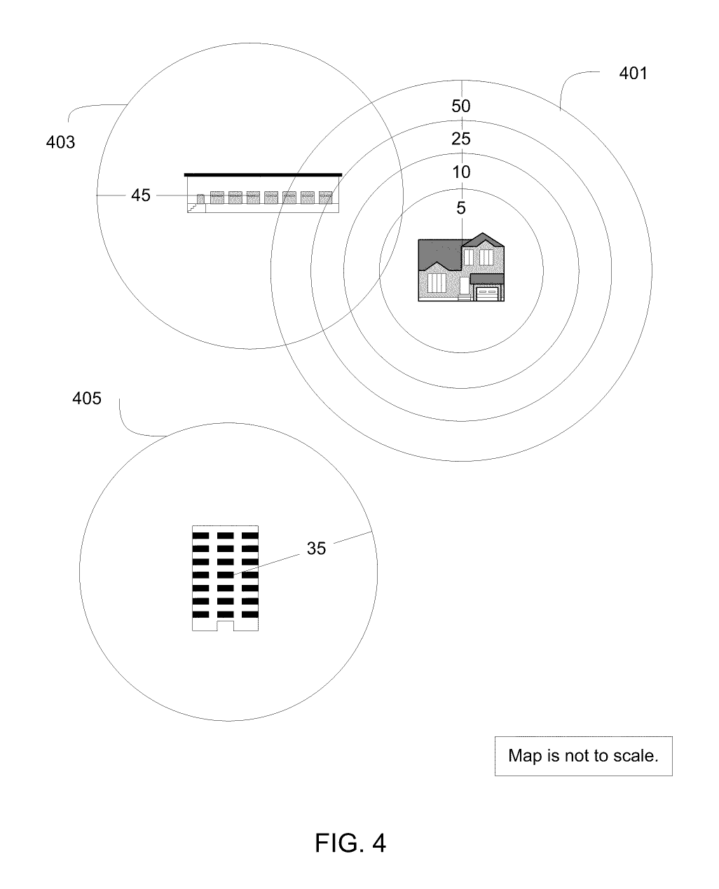

Referring to FIG. 4, it illustrates an area 401 that a series of coordinates (e.g., 5, 10, 25, and 50 miles away from a location of a person associated with the profile) which encompasses the location of a person that is represented by the geo coordinates associated with the profile. As mentioned above, these pre-determined coordinates are associated with the living resume. When Employer A searches for candidates within 45 miles of the warehouse 403 for Employer A, the profile will show up in the search results of potential candidates for Employer A. However, when Employer B searches for candidates within 35 miles of the office 405, the profile 401 will not show up in the results of potential candidates for Employer B since the person is located outside of the area associated with Employer B.

Turning back to FIG. 3B, if the profile standardization engine 113 determines 307 that location information could not be located in the raw profile, the profile standardization engine performs 313 a process 313 for uncovering (or discovering) the location information. The uncover location process 313 will be described in further detail below with respect to FIG. 3E. The profile standardization engine 113 determines 315 whether location information is found as a result of the uncover location process 313. If the location is found as a result of the uncover location process 313, then that location is passed to the write location process 309 where the location information is geocoded and discarded as previously discussed. If the location is not found after the uncover location process 315, then the profile standardization engine 113 discards 311 the raw profile.

Referring to FIG. 3C, one embodiment of a method is illustrated of the process 305 for identifying the location information from the raw profile. Particularly, the process 305 describes how to identify a country in which the person associated with the raw profile resides. Note that in alternative embodiments, other steps may be included in the process.

The profile standardization engine 113 analyzes 301 the raw profile and determines 317 whether the raw profile comprises a postal code, e.g., zip code. By way of example, if a zip code is identified, the profile standardization engine 113 accesses 319 a zip code list that correlates zip codes with country names. The profile standardization engine 113 identifies 321 a corresponding country name from the zip code list that is associated with the zip code identified from the raw profile. For example, the zip code “94041” corresponding to the city of Mountain View, Calif. would be associated with the country “United States of America” in the zip code list. If the profile standardization engine 301 matches the zip code to a country name from the zip code list, then the profile standardization engine 113 has successfully 323 identified location information from the raw profile.

However, if the profile standardization engine 113 is unable to map a zip code from the raw profile to a country in the zip code list, the profile standardization engine 113 searches 325 for a free format location description (e.g., a location string) in the raw profile. In one embodiment, the free format location description is a slang description of a geographic location, such as “Greater Boston Area.” In other words, the free format location description is an unofficial description of the geographic location as recognized by the government in which the location resides. If a location string is found in the raw profile, the profile standardization engine 113 accesses 327 a location slang list. In one embodiment, the location slang list maps free format location descriptions of geographic locations to official country names associated with the geographic locations. For example, the free format location description “Greater Boston Area” is mapped to “United States of America.” If the country name is found by matching the location string against the location slang list, the identification of the location information is successful 323. Otherwise, if the country name cannot be determined from the location string, then the profile standardization engine 113 uses a map application programming interface (API) process, e.g., a Google Maps API process 331 to identify the country name associated with the location string.

By way of example, the Google Maps API process 331 uses the public Google Maps API to determine a geographical name from the location string. For example, the Google Maps application can be used to determine that the location string “Greater Boston Area” corresponds to the “United States of America.” If a geographical name is determined and it is a single match 337 (e.g., “Orange County” is not a single match because there is an Orange County, Calif. and an Orange County, Fla.), then the search parameters and the results are both saved by the profile standardization engine 113 in the location slang list for future use in searches.

However, if there is no match or if there are multiple matches, the profile standardization engine 113 determines 339 whether the location string has been cleaned. If the location string has not been cleaned, the profile standardization engine 113 performs the clean location process 341 to clean the location string.

Referring to FIG. 3D, one embodiment of the clean location process is shown. In one embodiment, the clean location process 341 takes ambiguous location descriptions, such as “The Greater Boston Area” and removes (e.g., filters) common words and characters used by people to describe a geographic area. The profile standardization engine 113 starts with a string of words or a phrase that represent the location string 343. The profile standardization engine 113 determines 345 whether words in the location string match words in a filtering table of words that should be removed from location name. In one embodiment, the table comprises words that people and systems use to define general or specific geographical areas that are typically not standard (official) for the name of a location. For example, the filtering table may include words such as “AND,” “&,” “GREATER,” “AREA,” and “LOCAL.” Words can be added to this table at any time.

The profile standardization engine 113 removes 347 words from the location string that match words in the filtering table thereby creating 349 a cleaned location string. The cleaned location string represents the location string which has been removed of any ambiguous words. Referring back to FIG. 3C, the cleaned location string is provided 331 to the Google Maps API to identify the country name associated with the cleaned location string.

However, if the profile standardization engine 113 determines that the location string has already been cleaned, the profile standardization engine 113 accesses 327 the location slang list. The profile standardization engine matches 351 the cleaned location string against the location slang list to determine the country associated with the location string. If a country is found, the profile standardization engine 113 has successfully 323 identified the location information from the raw profile. Otherwise, if there is no match or if there are multiple matches and the location string has already been passed through the clean location process 341, then the profile standardization engine 113 performs the process 313 to uncover the location from the raw profile.

If a location string is not recognized in the raw profile, the profile standardization engine 113 searches 333 the raw profile for data elements that contain any other address information. For example, the profile standardization engine 113 may identify city information, region information, state information, or town information from the raw profile. If other address information is found, then the profile standardization engine concatenates 335 (i.e., creates) a location string from the identified information from the location information that is available in the raw profile. The profile standardization engine 113 matches 327 the concatenated location string against the location slang list to determine the country name associated with the concatenated location string as previously discussed above. If no other address information is found, the process for identifying the location information from the raw profile ends and the raw profile is deleted by the profile deletion engine 115.

FIG. 3E illustrates the functional stages of the process 313 to uncover the location from the raw profile. In one embodiment, the profile standardization engine 113 searches 353 the work experience indicated in the raw profile for the location information. The profile standardization engine 113 also searches 355 the education records indicated in the raw profile for the location information.

Turning to FIG. 3F, a detailed flow diagram of the process 313 to uncover the location from the raw profile is shown. In one embodiment, the uncover location process 313 derives a probable location of the person associated with the raw profile based on the sum of the other location information in the raw profile. The profile standardization engine 113 assesses information such as the person's current job location, locations in their history of jobs, and their education records to identify the location information.

In general, the profile standardization engine 113 searches 353 work experience records of the raw profile to identify the location information. The profile standardization engine 113 determines 357 whether the raw profile indicates that the person has any work experience. If the raw profile comprises work experience, the profile standardization engine 113 searches the work record to determine if the person is currently employed as indicated by a “CURRENT JOB” property. If the person is currently employed, the location of his or her current job is an indication of the location of the person.

The profile standardization engine 113 searches 359 the work record for any keywords pertaining to a current job. In one embodiment, the keywords comprise “CURRENT,” “CURRENT EMPLOYER,” “STILL EMPLOYED,” and any other words indicative that the person is currently employed. The profile standardization engine 113 may also search the work record to determine 361 whether a value for an “END DATE” property of the raw profile is null indicating that the person is still currently employed.

If the profile standardization engine 113 determines 363 that the work record is not a “Current” record, then the profile standardization engine 113 checks the raw profile for more work records. The profile standardization engine 113 iteratively reviews each work record for the “Current” property.

If the profile standardization engine 113 determines 363 that a work record is the “Current” work record, any location information obtained from that work record is passed to the get location process 305 as previously described above with respect to FIG. 3C. The profile standardization engine 113 determines 365 whether a location was identified as a result of the get location process 305. If the profile standardization engine 113 identifies a location then the profile standardization engine 113 uses the identified location in the write location process 309 where the location is geocoded.

If the profile standardization engine 113 determines that a location is not found as a result of the get location process 305, the profile standardization engine 113 matches 367 the employer name in the raw profile's work record against other profiles that contain the same employer data in their records. The profile standardization engine 113 determines 369 whether location information is determined from the employer data. If the employer name matches another employer with associated location information, then the location information of that employer is used by the profile standardization engine 113 in the write location process 309 where the identified location is geocoded.

If after each work record is checked and none are recognized as “Current” then the profile standardization engine 113 searches the work history in the raw profile for location information. Generally, the profile standardization engine 113 calculates the most common location from the collective work locations indicated in the person's work history by determining the geographic location the person has spent most of his or her time. This process will produce at least a state, but can also produce any other location description, such as, but not limited to, city, ZIP code, or a location string.

For each work record in the raw profile, the profile standardization engine 113 analyzes the work record to determine 373 any location information. Any location information contained therein is passed to the get location process 305. If no location information is determined from the work records, then the profile standardization engine 113 searches 355 the education records as will be described in further detail below.

After the get location process 305, the profile standardization engine 113 determines 375 whether any location information was identified as a result of the get location process 305. If location information is found, the profile standardization engine 113 saves 377 the information and determines whether 379 any more work records exit. If more work records exist, the profile standardization engine 113 searches the work records as described above.

If the profile standardization engine 113 determines 375 that the get location process 305 did not find result in a location, then the profile standardization engine 113 matches 367 the employer name 367 against other profile information as previously described above. If the employer name search results in location information 381, then the profile standardization engine 113 saves the location information 377, and the process continues to check 379 for more work records. After the last work record is processed, the profile standardization engine 113 uses the saved location information to calculate 383 a work location based on the saved information.

In one embodiment, after the last work record is processed, the profile standardization engine 113 groups similar work record locations into an array by: COUNTRY, STATE, CITY, ZIP, and/or GEO COORDINATES. The profile standardization engine 113 determines the location in which the person has worked most throughout his or her career. That is, the profile standardization engine 113 determines the highest count that represents the most common location the person has worked in throughout their career and selects the location as being associated with the person. In one embodiment, if the highest count is less than a threshold (e.g., 2 instances at the same location), then the location for the person is set to the most recent work experience which is passed to the write location process 309 where the location is geocoded.

If there are two or more locations with the same count that is greater than a threshold (e.g., 1 instance), then the location is set to the highest count with the most recent work experience. This location is passed to the write location process 309. If the raw profile does not have any work records, then the profile standardization engine 113 searches 355 the educational records for location information.

Referring now to FIG. 3G, one embodiment is shown of the process 355 for identifying location information from education records. Searching the education records allows the profile standardization engine 113 to identify location information for people without work records such as students, the unemployed, others who lack work experience, or from social networking sites, for example FACEBOOK, MYSPACE, or LINKEDIN.

In one embodiment, the profile standardization engine 113 determines 385 if the raw profile comprises education records. The education records describe the education history of the person associated with the raw profile such as the name of the college institution that the person attended, the degree obtained, or any other education related information. The profile standardization engine 113 scans each education record of the raw profile to determine whether the person is still a student. For example, the profile standardization engine 113 scans the raw profile for a “Current” student status.

To determine whether the person associated with the profile is still a student, the profile standardization engine 113 search 387 the education record for any indications that the person has graduated. These indications include “Graduation” data properties, “Graduated” flags, or any keywords pertaining to graduation such as a “GRADUATION,” “FINISH DATE,” or “DEGREE RECEIVED.” In one embodiment, the profile standardization engine 113 may search 389 the education record for an indication that the person has yet to graduate. For example, the profile standardization engine 113 may identify a null education “END DATE” property in the raw profile.

If the profile standardization engine 113 determines 391 that the education record is the most “Current” record from the process described above, then any location information obtained from that education record is passed to the get location process 305. The location information obtained from the education record may be a zip code, city, or state associated with the institution described by the education record.

The profile standardization engine 113 determines 933 whether the get location process 305 resulted in location information. Any location information found as a result of the get location process 305 is passed to the write location process 309 that geocodes the identified location. If a location is not found as a result of the get location process 305, then the profile standardization engine 113 identifies the institution name from the education record. The institution name is the name of the educational facility that the person attended, for example, a university, vocational school, or high school. The profile standardization engine 113 matches 395 the institution name from the education record against other profiles that contain the same institution name data in their education records in order to identify the location information from the other records.

The profile standardization engine 113 determines 397 whether the institution name is found as a result of the matching. If the institution name is found, then the location information from the other records is passed to the write location process 309 where the identified location is geocoded. If the institution name is not found located in the other records, the profile standardization engine 113 analyzes the next education record if any exist 399. If there is no education records left in the raw profile, or after reviewing every education record, then the profile standardization engine 113 discards 311 the raw profile.

### Education Standardization

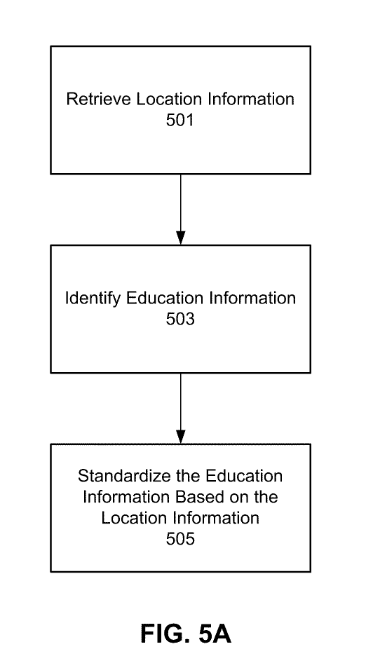

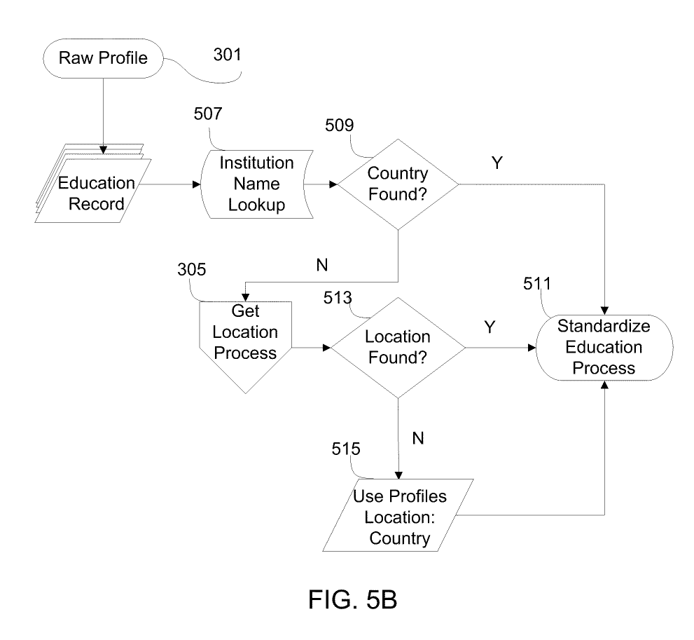

Turning now to FIG. 5A, one embodiment of the functional stages to standardize education information is shown. Standardizing the education information allows for the education information within profiles to be uniform thereby making it easier to evaluate the information. In one embodiment, the profile standardization engine 113 retrieves 501 the location information identified from the processes described with respect to FIG. 3. The profile standardization engine 113 identifies 503 the education information from the education records of the raw profile. The profile standardization engine 113 standardizes 505 the education information according to the identified location information. Typically, countries around the world have different levels of education. For example, college education in one country may be the equivalent of high school education in the United States of America. Thus, there may be ambiguities within a raw profile in terms of the education a person has received. The profile standardization engine 113 maps the education levels included in a person's raw profile to standardized education levels corresponding to the location in which the person currently resides.

Referring to FIG. 5B, one embodiment of the process to standardize the education information of a raw profile is shown. For each education record in the raw profile, the profile standardization engine 113 compares 507 the name of the institution indicated in the record with an institution country table. In one embodiment, the institution country table maps institutions (e.g., universities, colleges, or vocational schools) from around the globe to the countries in which the institutions are located. Thus, the profile standardization engine 113 identifies the country in which an identified institution is located by mapping the institution to a corresponding country in the institution country table.

The profile standardization engine 113 determines 509 whether the institution is included in the institution country table. If the institution name is matched and a corresponding country is identified, the profile standardization engine 113 country is used in the process 511 to standardize the educational information which will be described in further detail below.

However, if the institution name is not matched to a country in the institution country table, the profile standardization engine 113 performs the get location process 305 to identify the location information associated with the education record. The profile standardization engine 113 determines 513 whether the get location process 305 resulted in a county being determines for the institution. If a country is found, the profile standardization engine 113 uses the country in the standardize education process 511. However, if a country is not found after going through the get location process 305, then the location information associated with the raw profile is used in the standardize education process 511.

In one embodiment, the standardize education process 511 standardizes the various ways people enter, spell, reference, or notate the level of education, in terms of academic degrees, to basic education groups. In other words, the profile standardization engine 113 standardizes the entire education record included in a raw profile to basic education groups. In one embodiment, the education record is searched against map-translation terms assigned to each of the educational levels for a country.

Table II shows the map-translation terms; each country has a table of all the country's educational levels.

TABLE II

| Level | Slang | Group |
|---|---|---|
| GED | GED, General Ed Degree, General | High School |
| | Ed, ED, general | |
| Bachelors | Bachelors, BA, BS | Bachelors |
| Masters | Masters, MA, MS | Advanced |
| Doctorate | Double doctorate, PhD | Advanced |

A field in each record contains the slang or common terms used to define each educational level. The profile information entering into the profile optimization server 100 is from information sources 101 that allow people to enter free-format or loose information. Thus, people can enter in any type of value when proving information to the information source 101 rather than pick from a structured list. The field with the slang terms eliminates the issues a recruiter faces in trying to provide an equal recruitment process, especially with spelling differences or when information is missing.

Each educational level is assigned a Group name, which is recorded into the raw profile's optimized living resume. Since employers 107 are not always sure what level of education they want in their candidate requirements to a specific degree, such as a Master's degree or a Doctoral degree, the educational levels are grouped into basic selection groups to make the search process simpler for the employer 107: HIGH SCHOOL, ASSOCIATES, BACHELORS, ADVANCED. Thus, a search result for ADVANCED levels of education will return candidates with Master's degrees or Doctoral degrees, or other advanced degrees.

In one embodiment, the profile standardization engine 113 maps education level globally, as shown in Table III. The global mapping enables a search to include people with foreign degrees. For example, globalizing educational levels allows a United States (U.S.) based user who is searching globally for a candidate with at least a BACHELORS level of education, to find profiles of people with international degrees equivalent to the U.S. BACHELORS degree.

TABLE III
International Degree Equivalency

| Level | Slang | Group | Regional |
|---|---|---|---|
| GED | GED, General | High | New Zealand: School |
| | Ed Degree, | School | Certificate |
| | General ed, ed, | | New Zealand: Sixth Form |
| | general, and so on. | | Certificate |
| | | | Australia: Certificate 1 |
| | | | Other countries . . . |
| Bachelors | Bachelors, ba, bs, | Bachelors | United Kingdom - O Level |
| | and so on. | | Other countries . . . |
| Masters | Masters, ma, and | Advanced | Germany: Diplom |
| | so on | | Germany: Magister |
| | | | Other countries . . . |
| Doctorate | Double doctorate, | Advanced | Argentina: doctorado |
| | PhD, and so on. | | Other countries . . . |

### Work Experience Standardization

In one embodiment, the optimized living resume or optimized profile is based on a standard taxonomy structure and rule set. Essentially, there is a fixed set of options that every element of information is selected from. The elements are stored in the profile information. A standard taxonomy resolves the exclusion of applicable candidates due to spelling errors, and resolves differing job titles to enable equalized candidate results. To determine which set of fixed options to exercise on select profiles at select terms, a series of processes, similar to the location processes, determines the element from the taxonomy that best represents the information.

Part of the taxonomy includes using a public standard for job information that provides job attributes such as skills, tasks, competencies, work activities and a number of other parameters useful in defining the job's ideal person or candidate. In one embodiment, the public standard for job information utilized is the United States Department of Labor/Employment and Training Administration (USDOL/ETA) O*NET (Occupational Information Network) OnLine resource, found on the World Wide Web at online.onetcenter.org. Alternatively, another data set or a future public standard can be utilized as the standard for job information.

To derive the best potential O*NET Standard Occupational Classification (SOC) Code associated with the work records of a raw profile, a third-party product, O*NET-SOC AutoCoder is used. The O*NET-SOC AutoCoder takes a block of text, such as a job description from a work experience record, and returns a list of probable O*NET SOC occupational codes that are suitable for job classification.

The use of O*NET eliminates the problems of various job titles being interchangeably used for the same job description or function. For example, in a search for “ACCOUNTANT,” a typical search engine that works on key words will find people who are or have been an “ACCOUNTANT” provided that “ACCOUNTANT” is included in their job title or description. Using the O*NET-SOC AutoCoder as part of the process below allows searches to uncover not only an “ACCOUNTANT” but also other titles that do not necessarily have “ACCOUNTANT” in the job title or description such as “FINANCIAL ANALYST” or “CFO” or “BOOKKEEPER.” Thus, the O*NET SOC occupational codes allows for the identification of individuals that are qualified for a particular position based on their job history even though the person has not held the title of the position in the past.

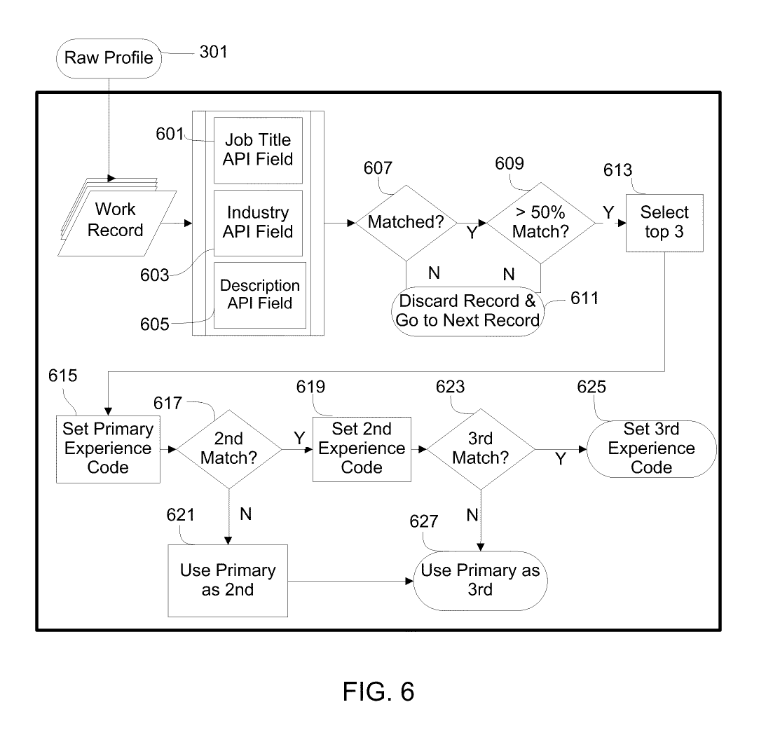

Referring not to FIG. 6, one embodiment of a process for retrieving O*NET SOC occupational codes for a raw profile's work records is shown. FIG. 6 describes the identification process of occupational codes that correspond to the person's work records indicated in the raw profile. The result of the process is the person's work records are mapped to experience codes that describe the person's work history. Each work record from the raw profile is passed to the Get AutoCoder Process of the profile standardization engine 113. As previously mentioned, the Get AutoCoder is a third-party product which may be incorporated into the profile standardization engine 113 as described herein or may be used independently from the profile standardization engine 113.

In one embodiment, the profile standardization engine 113 identifies the job title indicated in the raw profile. The job title is passed into the AutoCoder: JobTitle API field 601. Similarly, the profile standardization engine 113 identifies the job industry indicated in the raw profile and passes the job industry to the AutoCoder: Industry API field 603. Lastly, the profile standardization engine 113 identifies any job overview information indicated in the raw profile and passes the job overview, job title, and job industry to the AutoCoder: Description API field 605.

The profile standardization engine 113 determines 607 if the AutoCoder determined any experience codes that match the work experience of the person which is indicated in the work records of the raw profile. If the AutoCoder returns no matches, then the work record is discarded 611 and the next work record is passed into the AutoCoder as described above.

If the AutoCoder returns one or more results, the profile standardization engine 113 determines 609 whether the results indicate at least a threshold match (e.g., 50%) indicating that the person's work experience matches (i.e., is relevant) one or more O*NET SOC occupational codes. If there are no matches above the threshold, the profile standardization engine 113 discards 611 the current record and the next record is passed to the AutoCoder.

If the AutoCoder returns one or more results and they have more than a threshold match, the profile standardization engine 113 selects 613 the top scoring results to be associated with the profile. In one embodiment, the profile standardization engine 113 selects the top three scoring results for the primary, secondary, and third experience codes that are included in the optimized living resume. The experience codes represent the positions that best match the person's work records. From the top scoring results, the highest scoring result's O*NET Code is set 615 as the primary experience code for the work record. If there is a second match 617, then the second highest scoring result's O*NET Code is set 619 as the secondary experience code. Otherwise, if a second match does not exist, then the primary experience code is set 621 as the secondary experience code. If there is a third match 623, then the third match's O*NET Code is set 625 as the third experience code. Otherwise, if there is no third match, then the primary experience code is also set 627 as the third experience code. The Get AutoCoder Process thus produces three O*NET-SOC Codes. A example of three O*NET-SOC Codes associated with the job title “Accountant” is shown in Table IV, which are then assigned to the individual work record from which the job title was derived. The three O*NET-SOC Codes describe other positions in which the person may be qualified for. Thus, the raw profile has been standardized into a living resume once the education and work records have been standardized as described above.

TABLE IV

| Job Title | Primary | Secondary | Third |
|---|---|---|---|
| Accountant | 13-2011.01 | 13-2011.00 | 13-2011.04 |

In sum, in the Get Auto-Coder Process above, a free format job title is rationalized down to three highly probable O*NET-SOC Code matches. This allows the profile to be included in the search process for any job that falls into these three job categories. This typically represents three n×n chances the profile can be found for a relevant job (potential opportunity) where “n” is the number of jobs in that category.

Profiles that were slightly misclassified by the Auto-Coder due to some anomaly or to poorly written job titles making it difficult to determine the exact O*NET match can still be found in a search. The profile optimization server 100 basically provides a “fuzzy logic” approach to help decide individuals that are included in a search based purely on their work history.

### Optimizing the Raw Profile for Search

In one embodiment, the profile standardization engine 113 further optimizes the living resume for use in search by normalizing the employee skills that a person has or can have accumulated over their entire career. In one embodiment, the employee skills describe skills, tasks, competencies, work activities, education, knowledge and working styles that the person has accumulated over his or her career. The optimization enables searches to produce a quality result set, as well as enabling a ranked result set. A work-life graph or work experience attribute matrix (WEAM) is a predictive competency matrix summarizing all the skills and experiences a person has or can have amassed over their entire career.

In one embodiment, the attributes in the work-life graph are based off of the United States Department of Labor (USDOL) O*NET standard. Alternatively, the attributes in the work-life graph can be based off of any occupational standard database. The work-life graph describes a score for each attribute required in a job, that relates to the level of application, proficiency, and/or exposure a candidate performing the job should be at, when compared in specific time periods. Each O*NET job (a job with an assigned O*NET-SOC Code described above) includes a series of attributes that define the skills, competencies, tasks, and other related requirements specific to the job. In other words, each experience code has a set of associated attributes that describe the skills, competencies, and/or tasks related to the experience code.

O*NET has defined these core job related attribute sets as: skills; tools & technology; knowledge; abilities; work activities; work context; work styles; and work values. Each attribute further include a number of relevant sub-attributes required for the job. For example, the skills attribute set for an “accountant” may comprise: critical thinking, decision making, and systems analysis.

O*NET assigns each attribute a weight, quantifying the importance of that attribute to the associated job. The value of the weight is utilized as a multiplier to extract an accumulated score amassed during a person's time in a job position for each attribute pertaining to that job. The multiplier produces approximately 50,000 different job attributes, which are ordered, ranked, and weighted for a profile. These job attributes are mapped and scored during a search for potential job candidates to deliver a ranked result set based on the combination of predicative competency across individual attributes and across attribute sets as they apply to various jobs.

The mapping and scoring allows for two individuals with almost an identical work history to be ranked by their experiences or actual performance, as opposed to just by their job titles. For example, if two people working in the same role for the same amount of time move into the same promotion at the same time, but one person also performed a specific function in the previous role that enhances the person's skills for the promotion, then the person without the additional skills will rank lower in competency (shared attribute scores) than the other person.

In one embodiment, the profile standardization engine 113 scores each attribute for each job in the profile's work history and formulates a single “competency score” which is the total acquired competency a person has in each attribute. The competency score assigned by the profile standardization engine 113 to a profile for any attribute is determined by the following factors:
a. The length of time in which the person performed the job described by the attribute;
b. The length of time passed since the person last performed the job; and
c. The level of the job, based on requirements, such as experience, training, education, or skills.

Accordingly, the competency score will rank a person who is currently performing a job for 3 years higher than a person who performed the same job for 10 years, but 5 years ago. Attributes sets are also ranked according to importance. The Attribute Set is valued in relation to the effect its score has on the overall search.

Table V shows examples of multipliers, or nominal values, which are used to calculate a score for each individual attribute. Other weights may be used in alternative embodiments. In the example shown below, a score for a SKILL based Attribute is about twice as valuable as an Attribute from TOOLS & TECHNOLOGY according to one embodiment. This multiplier is known as the AttributeSet.Multiple.

TABLE V

| | Multiplier |
|---|---|
| | Importance of Attribute |
| | Set in relation to another |
| Attribute Set | (set) in the overall Search |
| Skills | 2 |
| Tools & Technology | 1.2 |
| Abilities | 1 |
| Knowledge | 1 |
| Work Activities | 1 |
| Work Context | 0.8 |
| Work Styles | 0.7 |
| Work Values | 0.6 |

Another multiplier is applied to the score based on the length of time a person performed the job. This multiplier is known as Time.Scalar, examples of which are shown in Table VI. Other scalar values may be used in alternative embodiments.

TABLE VI

| Years in a Role | | Scalar |
|---|---|---|
| 0-1 | Year | 0.2 |
| 1-2 | Years | 0.3 |
| 2-3 | Years | 0.4 |
| 3-4 | Years | 0.6 |
| 4-5 | Years | 0.8 |
| 5-6 | Years | 0.9 |
| 6-8 | Years | 0.95 |
| More than 8 | Years | 1.0 |

Another multiplier is based on the length of time passed since the person last performed the job. Lapsed time since experience gained degrades or increases the value of the competency. This multiplier is known as Recent.Scalar, examples of which are shown in Table VII. Other scalar values may be used in alternative embodiments.

TABLE VII

| Time Set | | Scalar |
|---|---|---|
| 0-3 | Years ago | 1.0 |
| 3-6 | Years ago | 0.7 |
| 6-10 | Years ago | 0.5 |
| More than 10 | years ago | 0.1 |

The work-life graph is built using the weighted attributes as the starting score for the attribute, and then the multipliers are used to formulate a competency score for the attribute that relates to the person's time in the job. In one embodiment, weighted attributes are attributes with an assigned O*NET score. The score is based on the attribute's importance in performing a job.

In one embodiment, the profile standardization engine 113 assigns to each work record in a raw profile a time value (TIME). If the work record indicates a start date and an end date, then the time value is set by subtracting the start date from the end date. The time value thus describes the length of time in which the person held the position indicated in the work record.

Otherwise, if the profile standardization engine 113 is unable to identify a start date in the work record, then the date at the present time (i.e., the current date) is set as the start date for the record. If the end date is missing, the TIME is set to a default value such as 18 Months. The profile standardization engine 113 then identifies the Time.Scalar value corresponding to the TIME value. For example, if the TIME value indicates that the person worked at position for 2.5 years, the profile standardization engine 113 identifies the scalar value of 0.4 to weight the TIME value.

Similarly, the profile standardization engine 113 then identifies the Recent.Scalar value corresponding to the length of time passed since the person last performed the job. For example, if the person associated with the profile last performed the job 1 year ago, then the 1.0 scalar value is used to weight the length of time passed.

In one embodiment, for each weighted attribute identified in O*NET that is related to the job, a Competency Score is calculated by the following formula:

Score=WeightedAttribute.Value×Time.Scalar×Recent.Scalar×AttributeSet.Multiple;

In the above equation, the WeightedAttribute.Value describes the value of the attribute for a particular job as defined by O*NET. In one embodiment, the following equation is used to update the work-life graph.

Update work-life graph.Attribute.Score=Previous work-life graph.Attribute.Score+Score;

In one embodiment, the “Score” for a particular attribute is cumulative across all jobs in a person's career. As new jobs for the person are processed, the “Score” for an attribute is calculated in the manner defined above, and the new “Score” is equivalent to “Previous work-life graph.Attribute.Score” plus the new “Score.” Thus, the scores for an attribute are added to itself as the work-life graph.Attribute.Score is calculated for the attribute across multiple work experiences leading to accumulation of the person's work history.

The result is a compounding or aggregate “Competency Level”, as a score, for each job attribute a person has experienced over their career. If a person has been exposed to the same Attribute multiple times from various jobs, then the work-life graph.Attribute.Score ensures that the person's competency level adjusts appropriately in the aggregate. In one embodiment, the work-life graph is re-calculated on a periodic basis (e.g., daily, weekly, monthly) to update the scores based on real time to ensure that people with “Current” experiences continue to score higher than people with past experiences.

As described above, in one embodiment eight O*NET Attribute Sets define key areas of work experience:

SKILLS;

TOOLS & TECHNOLOGY;

KNOWLEDGE;

ABILITIES;

WORK ACTIVITIES;

WORK CONTEXT;

WORK STYLES; and

WORK VALUES.

The individual Attributes that have been scored in the process described above can be grouped into these Attribute Sets to give combined scores for a set. In one embodiment, the attribute sets are bundled into two groups, SKILLS and JOB FIT, as shown in Table VIII.

TABLE VIII

| GROUP | CONTAINS O*NET ATTRIBUTE SETS |
|---|---|
| SKILLS | Skills |
| | Tools and Technology |
| JOB FIT | Knowledge |
| | Abilities |
| | Work Activities |
| | Work Context |
| | Work Styles |
| | Work Values |

With the two groups, the profile standardization engine 113 pre-calculates two scores for every job a person has performed, and for every potential job the person can perform. The SKILLS and JOB FIT scores for every job in the profile is saved to the optimized living resume. Further use of the SKILLS and JOB FIT scores is in the Search and Rank algorithm.

In one embodiment, the social behaviors derived from a raw profile may also be incorporated into the work life graph of a person. The derived behaviors are indicators which are not explicitly expressed in a profile that may also be used to identify talent. As described previously, the profile optimization server 100 may identify the frequency in which a person switches jobs or industries (e.g., semiconductor industry to electronic design automation industry). This social behavior may be included (i.e., scored) in the person's work life graph as a social attribute which allows the profile optimization server 100 to identify positions for the person that are in line with the social attribute of the person. In this example, the social attributes of the person may indicate that the person may leave his or her current employment within the next few months. Accordingly, the profile optimization server 100 may consider this social factor when scoring the work life graph for the person.

In another example, the profile optimization server 100 may identify that a person's social community (e.g., family, friends, etc.) is located in a specific area such as New York. Thus, this social attribute is indicative of a retention probability for a position in New York compared to San Diego where the person lacks a social community in this example. This allows the profile optimization server 100 to score the potential candidate accordingly based on the retention probability indicated by the social attribute.

### Talent Identification

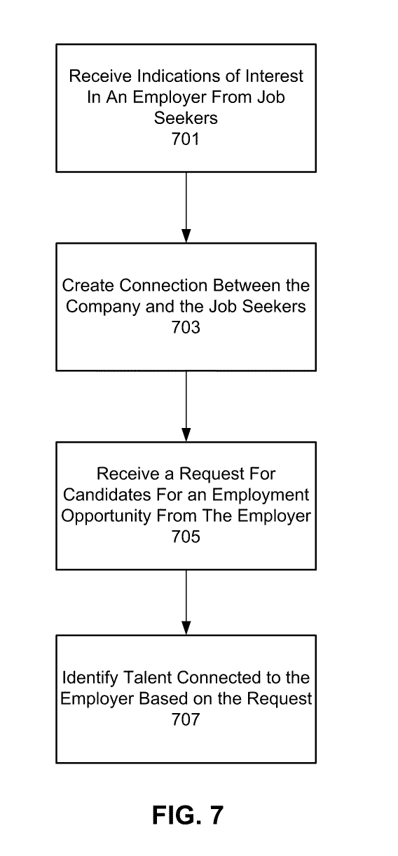

Turning now to FIG. 7, there is shown one embodiment of a method for identifying talent for employment purposes according to one embodiment. Note that in other embodiments, other steps may be included other than those illustrated in FIG. 7.

As previously described, an employer 107 may expend money and time to generate demand for jobs at the employer 107. The employer 107 may post job openings or general company information on one or more profile information sources 101 to generate interest in the company. This information may also be posted on a website of the employer 107. Job seekers using clients 105 may access the profile information sources 101 or the employer's website to learn additional information about the employer 107 or to post their resumes for available positions at the employer.

In one embodiment, the profile information source 101 or the employer's website may include a user interface element (e.g., a button) that allows users to indicate interest in the employer 107. By selecting the button, job seekers indicate that they are interested in the employer 107. The interest may reflect a job seekers desire in working for the company even though a position of interest is currently unavailable at the employer 107. The interest may also reflect a general interest in the employer 107 itself.

The profile optimization server 100 receives 701 indications of interest in an employer 107 from job seekers responsive to the job seekers selecting the user interface element. By indicating the interest in the employer 107, each job seeker permits the profile optimization server 100 to create 703 a connection between the employer 107 and the job seekers. In one embodiment, the connection is an association in the talent database 123 of the employer 107 with each job seeker who indicated interested in the employer 107. Thus, as more job seekers indicate interest in the employer 107, the employer's community of talent increases. The talent community is a rich resource from which the employer 107 may seek job candidates to fill open positions where the candidates are genuinely interested in working for the employer thus alleviating the need for the employer to spend additional resources (e.g., money) in trying to generate interest in the employer.

The profile optimization server 100 receives 705 a request for candidates for an employment opportunity from the employer 107. The request may originate from a representative of the employer 107 such as a recruiter or any individual associated with the employer 107 that needs an available position filled at the employer 107. In one embodiment, the request may include various search criteria. For example, the request may include search criteria explicitly specifying a job title associated with the available position at the employer 107.

Alternatively, the search criteria may describe job attributes of the available position such as required skills or education rather than the job title of the position. The job attributes describe the job skills and/or education required by the employer for the available position. A request in this form allows the profile optimization server 100 to locate potential job candidates with employee skills that match the job skills required by the position rather than merely locate individuals that held a matching job title. In one embodiment, employee skills may describe jobs held by the candidate, skills obtained through his or her work experience, education or any other source of skills such as volunteer work or hobbies.

Having not previously held the job title in the past does not necessarily indicate that the job candidates would be unable to fulfill the job skills (duties) required by the position. Thus, search results with candidates that possess the job skills required by a position are more meaningful to the employer 107 than simply a list of candidates that held the same job title in the past.

The search criteria may also include profile information describing a current employee at the employer 107. The current employee may represent a type of candidate desired by the employer 107 due to the employee skills (qualities) possessed by the candidate such as his or her skills or education. Such a request indicates that the employer 107 is seeking other individuals that comprise similar attributes as the current employee.

The profile optimization server 100 identifies 707 talent (i.e., people) connected to the employer based on the search criteria in the request. The profile optimization server 100 searches the talent database 123 for a set of individuals who are connected to the employer 107. Thus, the profile optimization server 100 searches the employer's own talent community for individuals to fulfill the position.

For each individual in the set, the profile optimization server 100 may score the individual's optimized living resume. The profile optimization server 100 determines a current competency level for each attribute set (e.g., skills, tools & technology etc.) indicated in the resume as previously described above based on the search criteria included in the request received from the employer 107. In one embodiment, the profile optimization server 100 may also evaluate the social attributes for each individual when scoring the living resumes. The profile optimization server 100 may generate a ranked list of job candidates based on scores for the optimized living resumes of the individuals that are connected to the employer 107. In one embodiment, the profile optimization server 100 provides the ranked list of job candidates to the employer 107. This allows the employer 107 to contact individuals in the ranked list inviting them to apply for a particular position that is open at the employer 107. Alternatively, the profile optimization server 100 may contact the individuals in the ranked list on behalf of the employer 107.

In one embodiment, in the future if the same person were to visit another website or destination and indicated an interest in another company, the process to create the living resume need not be repeated. Rather, the existing living resume for the person may be added or associated with the talent community for the other company.

### Dynamic Clearing House

In one embodiment, the profile optimization server 100 may function as a dynamic clearing house for interactions between employers and job candidates. The profile optimization sever 100 aggregates living resumes for individuals looking for jobs (job seekers) and employer search demand from one or more talent communities (“Suppliers”). The profile optimization server 100 dynamically sets pricing in real-time based on the available skills (of job seekers) and required demand for job skills for jobs offered by one or more employers. The profile optimization server 100 collects revenue, clears and distributes funds to participating suppliers (talent community owners), on successful interactions between a job candidate and an employer. An interaction between an employer and a job candidate is instantiated by an employer. In one embodiment, these interactions comprise sending an email to the candidate, revealing a candidate's contact information, or set-up an interview for the candidate or a successful hiring of the candidate.

In one embodiment, the profile optimization server 100 accepts job seekers and searches from one or more talent communities. These talent communities may also be externally provided rather than generated by the profile optimization server 100 as described herein. The profile optimization server 100 calculates demand based on a weighted algorithm.

For all jobs currently open (e.g., verified through searches in the past X hrs), the profile optimization server 100 decomposes each job into its raw skills, ability, knowledge and competency requirement (as defined and weighted by O*Net or other taxonomy described above). From the decomposed information, the profile optimization server 100 creates a “job skill score” for each job. By iterating through each job, the profile optimization server 100 builds a “market demand score” for each of the skills, abilities, knowledge, etc. The “broad market demand score” is the current real time demand for skills across the system.

The profile optimization server 100 reviews each job and applies a weighting attribute group based on levels of education, experience, and training necessary to perform the occupation (Job Zone), as set in the taxonomy, the system multiplies the Job Skill Score by 1 for the highest Job Zone, then 0.75, 0.6, 0.5, 0.3 for example. In one embodiment, the profile optimization server 100 analyzes the geographic saturation for the jobs. That is, the profile optimization server 100 identifies the geographic location where the jobs are required and builds a “geographic demand weighting” (a weighting value) for the regions. In one embodiment, the weighting may be normalized by so that the most popular region is weighted with a value of 100 and the least popular region is weighted with a value of 1, for example.

The profile optimization server 100 reviews all the jobs in a region and using the taxonomy, groups the jobs by job title (e.g., accountant) and job family (e.g., business and financial operators) to create a “job title demand score” and a “job family demand score” for each region. For example, the most popular job title and/or family in each region is assigned a score of 100 whereas the least popular is assigned a score of 1.

When an employer in a region is looking for candidates they create a search for a job on the profile optimization server 100 or a website associated with the server 100. As candidates are displayed in the search results a price can be attributed to an interaction type with an individual candidate based on:

Market Value=(job skill score*geographic demand Score*(the greater of job title demand score or job family demand score)*candidate work life score for job title (as previously described above)*(a first constant (e.g., 1) if less than 30 candidates) or *(a second constant (e.g., 2) if greater than 30 candidates)

Email Interaction Cost=Market Value*InteractionPrice*0.1

Contact Reveal Interaction Cost=Market Value*InteractionPrice*0.15

Successful Interview Setup Cost=Market Value*InteractionPrice*0.2

Successful Hire Cost=Market Value*InteractionPrice*3

Note that in other embodiments. Other scores and weights may be used than those described above. As part of the search results, the profile optimization server 100 allows job seekers to pay to have their living resume highlighted or otherwise emphasized in search results (e.g., appearing in a different color or page location or results position). The amount a job seeker pays for this capability is managed by a typical ad bidding demand engine (third party) but this engine can be weighted dynamically using the market value score. The revenue collected from the interactions between an employer and a job seeker are in one embodiment shared with the profile optimization server 100, the supplier of the job seeker, and the supplier of the job (i.e., the employer).

In one embodiment, the above method may be implemented to identify talent that is non-employer specific. As previously described above, rather than receive interest in particular companies, job seekers may indicate general interest in a genre such as a particular work industry (e.g., engineer or human resources) or development phase of companies of interest (e.g., startup). The profile optimization server 100 may then create general communities of talent specific to that particular genre which may be searched to identify talent as described previously.

As related to the various embodiments described herein, it is noted that the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as determining or displaying or the like, refer to the action and processes of a computer system, or similar electronic computing device, that manipulates and transforms data represented as physical (electronic) quantities within the computer system memories or registers or other such information storage, transmission or display devices.

Certain described embodiments include process steps and instructions described herein in the form of an algorithm, for example, with respect to FIGS. 3A-3G, 5A-5B, 6, and 7. It should be noted that the process steps and instructions could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the processes note for the described embodiments are not described with reference to any particular programming language. It is appreciated that a variety of programming languages may be used to implement the teachings as described herein.

Referring back to FIG. 1, the profile optimization server 100 comprises various engines or modules. As is known in the art, the term engine or module refers to computer program logic utilized to provide the specified functionality. Thus, an engine or module can be implemented in hardware, firmware, and/or software. In one embodiment, program modules are stored on a storage device, loaded into memory, and executed by a computer processor or can be provided from computer program products (e.g., as computer executable instructions) that are stored in non-transitory computer-readable storage mediums (e.g., RAM, hard disk, solid state memories, or optical/magnetic media). Additionally, those of skill in the art will recognize that other embodiments of the profile optimization server 100 shown in FIG. 1 can have different and/or other modules than the ones described here, and that the functionalities can be distributed among the modules in a different manner.

The described embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure herein is intended to be illustrative, but not limiting, in scope.

What is claimed is:

1. A computer-implemented method for standardizing profile information into a standardized profile, the method comprising:
collecting profile information from one or more sources comprising at least one social networking source;
identifying, from the collected profile information, one or more attributes of a person describing education obtained by the person, a career history of the person, and location information associated with the person;
mapping the education obtained by the person to a standardized education level based at least in part on the location information;
predicting, from the career history of the person, employee skills accumulated by the person during the career history; and
creating the standardized profile based at least in part on the derived job skills and the standardized education level.

2. The computer-implemented method of claim 1, further comprising:
determining that the person has updated the profile information on the one or more sources; and
updating the standardized profile based on the updated profile information.

3. The computer-implemented method of claim 1, wherein identifying, from the collected profile information, location information associated with the person comprises:
identifying the location information based on the education obtained by the person.

4. The computer-implemented method of claim 3, wherein the identified location information corresponds to a location of an institution associated with the education obtained by the person.

5. The computer-implemented method of claim 1, wherein identifying, from the collected profile information, location information associated with the person comprises:
identifying the location information based on the career history of the person.

6. The computer-implemented method of claim 5, wherein the identified location information corresponds to a location of a current employer of the person indicated in the career history.

7. The computer-implemented method of claim of claim 1, wherein mapping the education obtained by the person to the standardized education level comprises:
identifying, from the location information, a country in which the person currently resides; and
mapping the education obtained by the person to the standard level of education associated with the identified country in which the person currently resides.

8. The computer-implemented method of claim 1, wherein deriving the skills accumulated by the person during the career history comprises:
identifying, from the career history, one or more job titles associated with the person during the career history; and
identifying one or more occupational codes from a public standard for job information that correspond to at least one of the job titles associated with the person, each occupational code describing the skills accumulated by the person during the career history.

9. The computer-implemented method of claim 1, wherein creating the standardized profile stores properties of the standardized profile that indicate the one or more sources from which the profile information is collected to avoid storing the standardized profile.

10. The computer-implemented method of claim 1, further comprising:
deriving social behavior of the person from at least one of the profile information or the social networking source for recruitment purposes.

11. A computer-implemented method for identifying potential employees for an employer, the method comprising:
receiving indications of interest in the employer from one or more people;
creating a community of people that are interested in the employer based on the received indications;
receiving a request from the employer for candidates for an unfilled position at the employer, the request including job skills associated with the unfilled position;
identifying standardized profiles for a plurality of people from the community, each standardized profile describing employee skills accumulated by a person associated with the profile during a career of the person, wherein at least one skill described by each of the standardized competency profiles matches a job skill associated with the unfilled position;
ranking each identified standardized competency profile based at least in part on a length of time in which the at least one skill was performed by the person associated with the identified standardized competency profile and a length of time since the at least one skill was last performed by the person; and
providing a ranked list of the identified standardized competency profiles to the employer based on the ranking.

12. The computer-implemented method of claim 11, wherein receiving indications of interest in the employer comprises:
receiving an indication of interest in the employer responsive to a person selecting a user interface element on a website of the employer, the selection of the user interface element signifying the interest in the employer.

13. The computer-implemented method of claim 11, wherein receiving indications of interest in the employer comprises:
receiving an indication of interest in the employer responsive to a person selecting a user interface element on a social networking website, the selection of the user interface element signifying the interest in the employer.

14. The computer-implemented method of claim 11, wherein a received indication from a person grants permission to create a connection between the employer and the person to monitor profile information for the person.

15. The computer-implemented method of claim 11, wherein creating the community comprises:
associating an identifier of a person that is interested in the company with an identifier of the company; and
storing the association.

16. The computer-implemented method of claim 11, wherein receiving the request from the company for the unfilled position further comprises:
receiving a job title of the unfilled position from the employer.

17. The computer-implemented method of claim 11, wherein receiving the request from the company for the unfilled position further comprises:
receiving, from the employer, profile information of a current employee of the employer, the profile information signifying a request for candidates with a similar profile information as the current employee.

18. The computer-implemented method of claim 11, wherein identifying the standardized profiles comprises:
scoring each of the standardized profiles for the plurality of people from the community based at least in part on the length of time in which the at least one skill was performed by the person associated with the identified standardized profile and the length of time since the at least one skill was last performed by the person.

19. The computer-implemented method of claim 11, wherein the employee skills accumulated by the person associated with the profile are derived from one or more occupational codes from a public standard for job information, the codes corresponding to at least one job title associated with the person.

20. The computer-implemented method of claim 11, further comprising:
receiving indications of interest in a general genre from one or more people; and
creating a community of people that are interested in the general genre from which an employer may search for candidates for unfilled positions.

21. A non-transitory computer-readable storage medium storing executable code for standardizing profile information into a standardized profile, the code when executed performs the steps comprising:
collecting profile information from one or more sources comprising at least one social networking source;
identifying, from the collected profile information, one or more attributes of a person describing education obtained by the person, a career history of the person, and location information associated with the person;
mapping the education obtained by the person to a standardized education level based at least in part on the location information;
predicting, from the career history of the person, employee skills accumulated by the person during the career history; and
creating the standardized profile based at least in part on the derived job skills and the standardized education level.

22. A non-transitory computer-readable storage medium storing executable code for identifying potential employees for an employer, the code when executed performs the steps comprising:
receiving indications of interest in the employer from one or more people;
creating a community of people that are interested in the employer based on the received indications;
receiving a request from the employer for candidates for an unfilled position at the employer, the request including job skills associated with the unfilled position;
identifying standardized profiles for a plurality of people from the community, each standardized profile describing employee skills accumulated by a person associated with the profile during a career of the person, wherein at least one skill described by each of the standardized competency profiles matches a job skill associated with the unfilled position;
ranking each identified standardized competency profile based at least in part on a length of time in which the at least one skill was performed by the person associated with the identified standardized competency profile and a length of time since the at least one skill was last performed by the person; and
providing a ranked list of the identified standardized competency profiles to the employer based on the ranking.

23. A computer system for standardizing profile information into a standardized profile, the computer system comprising:
a computer processor; and
a computer-readable storage medium storing executable code, the code when executed by the computer processor performs the steps comprising:
collecting profile information from one or more sources comprising at least one social networking source;
identifying, from the collected profile information, one or more attributes of a person describing education obtained by the person, a career history of the person, and location information associated with the person;
mapping the education obtained by the person to a standardized education level based at least in part on the location information;
predicting, from the career history of the person, employee skills accumulated by the person during the career history; and
creating the standardized profile based at least in part on the derived job skills and the standardized education level.

24. A computer system for identifying potential employees for an employer, the computer system comprising:
a computer processor; and
a computer-readable storage medium storing executable code, the code when executed by the computer processor performs the steps comprising:
receiving indications of interest in the employer from one or more people;
creating a community of people that are interested in the employer based on the received indications;
receiving a request from the employer for candidates for an unfilled position at the employer, the request including job skills associated with the unfilled position;
identifying standardized profiles for a plurality of people from the community, each standardized profile describing employee skills accumulated by a person associated with the profile during a career of the person, wherein at least one skill described by each of the standardized competency profiles matches a job skill associated with the unfilled position;
ranking each identified standardized competency profile based at least in part on a length of time in which the at least one skill was performed by the person associated with the identified standardized competency profile and a length of time since the at least one skill was last performed by the person; and
providing a ranked list of the identified standardized competency profiles to the employer based on the ranking.
